(19) United States
(12) Patent Application Publication
(10) Pub. No.: US 2010/0208043 A1
(43) Pub. Date: Aug. 19, 2010

(54) METHOD AND SYSTEM FOR CREATING A 3D EFFECT ON A DISPLAY DEVICE

(75) Inventor: Brent Hoffman, Mooresville, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD., Shekou, Shenzhen, Guangdong (CN)

(21) Appl. No.: 12/681,074

(22) PCT Filed: Oct. 31, 2007
(86) PCT No.: PCT/US07/83226

§ 371 Date: Mar. 31, 2010

(30) Foreign Application Priority Data
Oct. 18, 2007 (CN) 200710124030.3

(51) Int. Cl. H04N 13/04

(52) U.S. Cl. 348/53; 348/56; 348/E13.001

(57) ABSTRACT

A method of operating a digital video device to create an effect of a three-dimensional image comprises loading a left image into a frame buffer prior to displaying the left image on a display of the digital video device. The method additionally comprises writing a right image, displaying the right image to a right eye of a viewer, powering on a backlight to allow the right eye of the viewer to view the right image, powering off the backlight, loading a subsequent right image into the frame buffer prior to displaying the subsequent right image, writing the left image to the display, displaying the left image to a left eye of the viewer, powering on the backlight to allow the left eye of the viewer to view the left image and powering off the backlight.

### BACKGROUND

This section is intended to introduce the reader to various aspects of art which may be related to various aspects of embodiments of the present invention that are described below. This discussion is believed to be helpful in providing the reader with background information to facilitate a better understanding of the various aspects of embodiments of the present invention. Accordingly, it should be understood that these statements are to be read in this light, and not as admissions of prior art.

A two-dimensional (2D) display can create the effect of a three-dimensional (3D) image by presenting the viewer with a right-eye view and a left-eye view of the image. However, in order for the viewer to perceive the image in three dimensions, the viewer's left eye should only see the left-eye view and the viewer's right eye should only see the right-eye view. One way to accomplish this is for the display to alternate between right-eye and left-eye views. Correspondingly, the viewer wears a pair of LCD shutter goggles to block the right eye when the left-eye image is displayed and block the left eye when the right-eye image is displayed. This combination of alternating images and LCD shutter goggles permits each of the viewer's eyes to see only the appropriate view. Hence, the viewer perceives a 3D image on a 2D display.

This technique for creating a 3D image is ineffective on traditional LCD displays because known LCD displays cannot present the viewer with alternating images. The image on an LCD display is refreshed by updating each pixel individually. The time required to update every pixel on the display is equal to the incoming video rate. Therefore, by the time an image is formed on the display, it is already being updated with the new image. Because of this continual image updating process, alternating right-eye and left-eye views would result in the viewer seeing image transitions instead of s complete eye-appropriate views. This deficiency creates unacceptable 3D images.

### BRIEF DESCRIPTION OF THE DRAWINGS

In the drawings:

FIG. 1 is a block diagram of an electronic device in accordance with an exemplary embodiment of the present invention;

FIG. 2 is a block diagram of a display controller in accordance with an embodiment of the present invention;

FIG. 3 is a process flow diagram illustrating a method in accordance with an exemplary embodiment of the present invention; and

FIG. 4 is a graph illustrating a method in accordance with an exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

An exemplary embodiment of the present invention relates to an electronic device that is configured to create a 3D effect on a 2D display, such as an LCD. The device is configured such that image transitions which detract from the 3D effect are hidden from the viewer. In an exemplary embodiment of the present invention, this functionality may be accomplished by two procedures. In a first procedure, a frame buffer may write a previously loaded image to the display faster than it would ordinarily be written in present display devices. The image may then remain on the display until the next image is written. This technique may allow a complete image to be displayed for a period of time before the display transitions to the next image. In a second procedure, a backlight controller may power on the backlight for only the periods when a complete image is present on the display. During periods of transition, the backlight may be powered off such that the viewer will not see the transition between images. The combination of these two procedures may greatly enhance the quality of the 3D images being displayed and create a better 3D viewing experience.

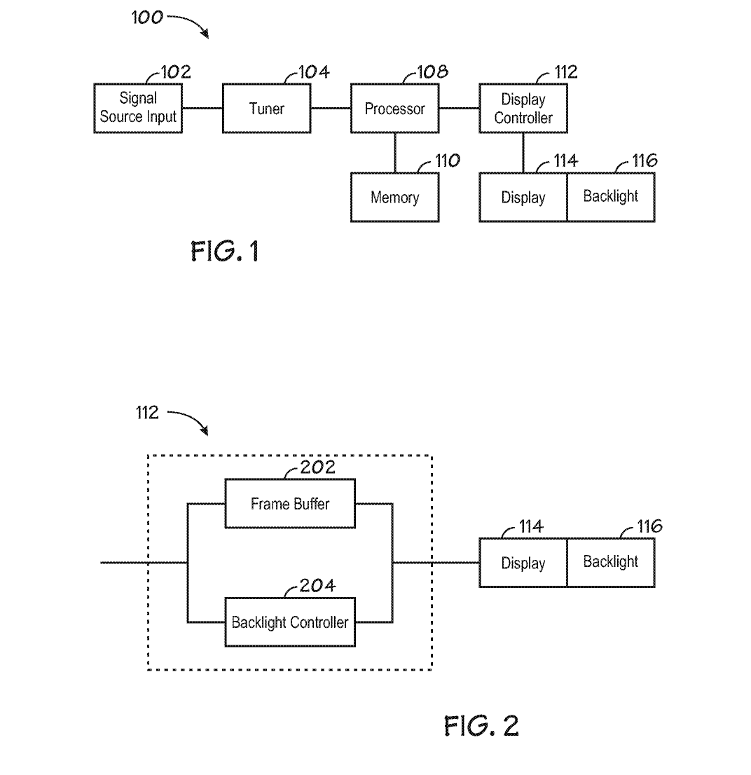

FIG. 1 is a block diagram of an electronic device that may employ an exemplary embodiment of the present invention. The electronic device is generally indicated by reference numeral 100. The electronic device 100, such as a television, a portable DVD player or the like, comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

A signal source input 102 may comprise an antenna input, an RCA input, an S-video input, a composite video input or the like. Those of ordinary skill in the art will appreciate that, although only one signal source is shown, the electronic device 100 may have multiple signal source inputs. The signal source input 102 is adapted to receive a signal that comprises video data and, in some cases, audio data. The signal received by the signal source input 102 may comprise a broadcast spectrum (e.g., if the signal source input 102 comprises an antenna) or a single channel of video and/or audio data (e.g., if the signal source input 102 comprises a DVD player or the like).

A tuner subsystem 104 is adapted to tune a particular video program from a broadcast signal received from the signal input source 102. Those of ordinary skill in the art will appreciate that input signals that are not received as part of a broadcast spectrum may bypass the tuner 104 because tuning may not be required to isolate a video program associated with those signals.

A processor 108 is adapted to control the overall operation of the electronic device 100. A memory 110 may be associated with the processor 108 to hold machine-readable computer code that causes the processor 108 to control the operation of the electronic device 100. The memory 110 may include one or more memory devices. For example, the memory 110 may include volatile memory components, non-volatile memory components, or a combination thereof. The memory 110 may be adapted to hold machine-readable computer code that causes the processor 108 to perform a method in accordance with an exemplary embodiment of the present invention.

In an exemplary embodiment of the present invention, a display controller 112 is adapted to cause a display 114 to hide image transitions from the viewer to create an improved 3D effect. The display 114 may comprise a liquid crystal display (LCD) or any other suitable display type. The display 114 comprises a backlight 116 that is used to facilitate presentation a visible image on the display 114. The display controller 112 may cycle power to a backlight and provide a frame buffer to achieve this result.

FIG. 2 is a block diagram of the display controller 112 coupled to the display 114 and the backlight 116. In an exemplary embodiment, the display controller comprises a frame buffer 202 and a backlight controller 204. The frame buffer 202 is adapted to load an image from the signal source input 102 (FIG. 1) and write the image to the display 114. In one exemplary embodiment of the present invention, the frame buffer 202 is capable of writing one image to the display and loading a subsequent image simultaneously. Those of ordinary skill in the art will appreciate that this functionality may also be accomplished with two frame buffers. In such an embodiment, a first frame buffer writes an image to the display 114 while a second frame buffer loads a subsequent image. When the next image is sent from the signal source input 102, the frame buffers would switch roles. That is, the first frame buffer would load the next image while the second frame buffer writes the previously loaded image. This process would repeat for the duration of the electronic device's operation.

The backlight controller 204 is adapted to power on and power off the backlight 116 at the appropriate times. The backlight controller 204 may power on the backlight 116 after each pixel on the display 114 has been updated to present a complete image. In one embodiment, the backlight controller 204 will receive a signal from the display 114 indicating that all pixels have been updated. At that point, the backlight controller 204 may power on the backlight 116. Similarly, the backlight controller 204 may power off the backlight 116 such that the display 114 will be substantially dark before the next image is written to the display 114. In this embodiment, the backlight controller 204 may receive a signal from the processor 108 (FIG. 1) indicating when the next image will be written to the display 114. The backlight controller 204 may also be configured to predict the length of time required for the display 114 to become substantially dark. Given both of these pieces of information, the backlight controller 204 may determine the appropriate time to power off the backlight 116. For the purposes of this exemplary embodiment, the display 114 has become substantially dark when a viewer under normal ambient lighting conditions cannot easily identify the image presented on the display 114.

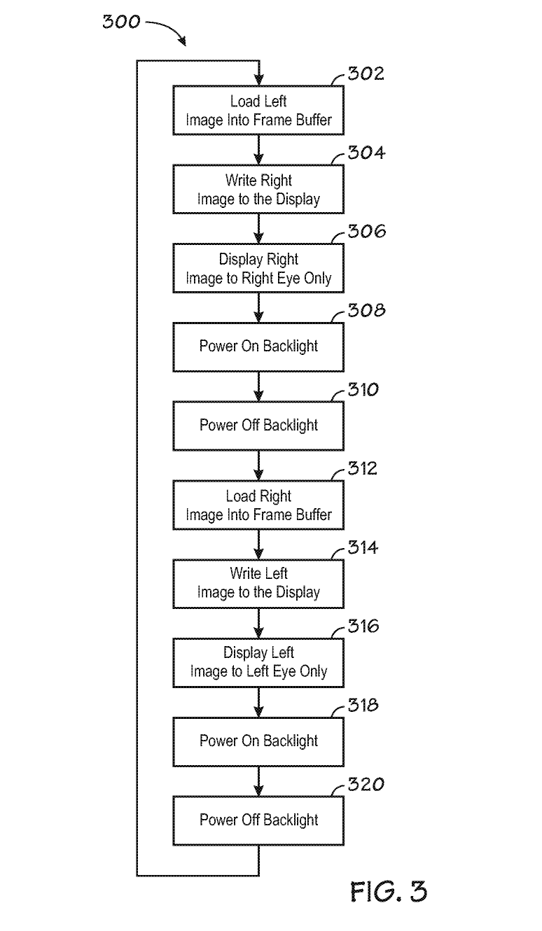

FIG. 3 is a process flow diagram illustrating a method in accordance with an exemplary embodiment of the present invention. The method is generally indicated by reference numeral 300. The method begins in block 302 and may be performed by the electronic device 100. However, the process is cyclical and may repeat during the entire period of operation of the electronic device 100 (FIG. 1). At block 302 the frame buffer 202 (FIG. 2) may begin loading an image (e.g., a left image or a right image). In the illustrated embodiment, at block 302 the frame buffer 202 (FIG. 2) begins loading a left image. The left image corresponds to what a viewer will see with his left eye after the image has been rendered on the display 114 (FIG. 1).

At block 304, an image opposite that loaded in block 302 may be written to the display 114 (FIG. 1) from the frame buffer 202 (FIG. 2). In the illustrated embodiment, a right image is written to the display 114 (FIG. 1) from the frame buffer 202 (FIG. 2). This right image was previously loaded into the frame buffer 202 (FIG. 2) just as the left image was loaded in block 302. By loading an image into the frame buffer 202 (FIG. 2) before it is written to the display 114 (FIG. 1), the rate at which the image is written may be increased. For example, if the frame buffer 202 (FIG. 2) is capable of writing an image to the display 114 (FIG. 1) faster than the video source can load the image into the frame buffer 202 (FIG. 2), using a frame buffer 202 (FIG. 2) increases the speed at which a display 114 (FIG. 1) may be updated with a new image. In addition, in this embodiment, while the left image is being loaded into the frame buffer 202 (FIG. 2), the right image is being written to the display 114 (FIG. 1).

In an exemplary embodiment, the display 114 (FIG. 1) is a liquid crystal display (LCD). In such an embodiment, writing an image to the display 114 (FIG. 1) involves sending the image to the display 114 (FIG. 1) while the display 114 (FIG. 1) updates each pixel. The process of updating the pixels may require more time than the process of sending the image to the display 114 (FIG. 1).

At block 306, the right image may be displayed to the right eye only. In this exemplary embodiment, this function may be achieved through the use of a pair of LCD shutter goggles. LCD shutter goggles may comprise a left lens and a right lens, each containing an LCD panel. When electrical current is applied to an LCD panel it becomes substantially clear. When the current is removed the panel becomes substantially dark. When a right image is present on the display 114 (FIG. 1), current may be applied to the right lens and removed from the left lens. At that point, the right lens becomes clear and the left lens becomes dark. Therefore, the viewer's right eye sees the image on the display 114 (FIG. 1), while the left eye does not. In this manner, the right image may be displayed to the right eye only. For the purposes of this exemplary embodiment, a lens in a pair of LCD shutter goggles is substantially clear when the viewer can easily identify the image on the display 114 (FIG. 1) with the eye behind the substantially clear lens when the viewer is oriented toward the display 114 (FIG. 1). Similarly, in the exemplary embodiment, a lens in a pair of LCD shutter goggles may be substantially dark when the viewer can not easily identify the image on the display 114 (FIG. 1) with the eye behind the substantially dark lens when the viewer is oriented toward the display 114 (FIG. 1).

At block 308, the backlight controller 204 (FIG. 2) may instruct the backlight 116 (FIG. 1) to power on. The backlight controller 204 (FIG. 2) may not begin to power on the backlight 116 (FIG. 1) until all the pixels on the display 114 (FIG. 1) have been updated to show the right image. In this manner, the viewer only sees a completely formed right image because the display 114 (FIG. 1) is substantially dark during the period of transition.

At block 310, the backlight controller 204 (FIG. 2) may instruct the backlight 116 (FIG. 1) to power off. The backlight controller 204 (FIG. 2) may begin to power off the backlight 116 (FIG. 1) such that the display 114 (FIG. 1) will be substantially dark by the time the pixels begin to transition between the right image and the left image. Again, the purpose of powering off the backlight 116 (FIG. 1) is to hide the image transition from the viewer. By powering off the backlight 116 (FIG. 1) during the period of image transition, the viewer only sees a complete eye-appropriate view, thereby enhancing the 3D effect.

At block 312, the frame buffer 202 (FIG. 2) may begin loading a subsequent right image. This image may not be displayed until block 304 in the next cycle of the process 300.

At block 314, the frame buffer 202 (FIG. 2) may begin writing the left image to the display 114 (FIG. 1). This is the same image that was previously loaded into the frame buffer 202 (FIG. 2) in block 302.

At block 316, the left image may be displayed to the left eye only. In an exemplary embodiment, this step comprises powering on a left lens in a pair of LCD shutter goggles such that the left lens is substantially clear and powering off a right lens in the pair of LCD shutter goggles such that the right lens is substantially dark.

At block 318, the backlight 116 (FIG. 1) may be powered on. Similar to block 308, the backlight 116 (FIG. 1) may not be powered on until all the pixels on the display 114 (FIG. 1) have been updated to show the left image.

At block 320, the backlight 116 (FIG. 1) may be powered off. As before, the backlight 116 (FIG. 1) may be powered off such that the display 114 (FIG. 1) is substantially dark by the time writing the next image to the display 114 (FIG. 1) begins. After this step, the process repeats for the duration of the operation of the electronic device 100 (FIG. 1). It should be noted that the left and right images may change throughout the process 300. For example, images may change when a user selects a different view to be presented on the display 114 (FIG. 1).

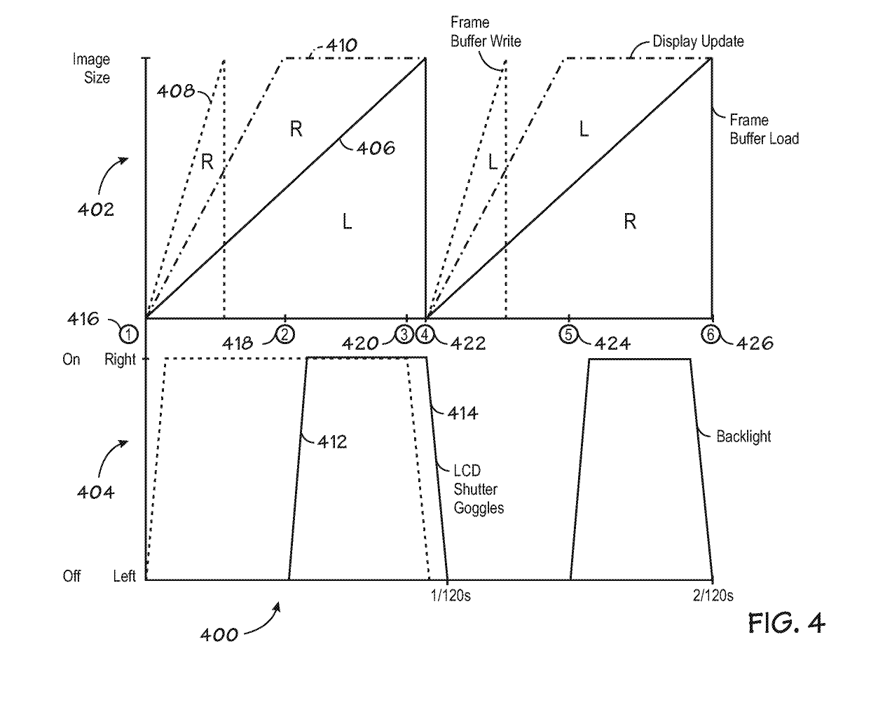

FIG. 4 provides a graphical representation of the timing and duration of the steps presented in the process flow diagram 300. The graph is generally indicated by reference numeral 400. In an exemplary embodiment, the signal received at the signal source input 102 (FIG. 1) has a video frame rate of 120 Hz. Those of ordinary skill in the art will appreciate that the video frame rate is dependent upon the signal and can vary based on the specifications of the device transmitting the signal. In an embodiment with a video frame rate of 120 Hz, the signal source input 102 (FIG. 1) requires 1/120th of a second to receive all the data for a given image. As soon as the reception of one image is complete, the next image is transmitted, and the process repeats every 1/120th of a second.

The 120 Hz video frame rate embodiment of the invention is presented in graphical form by the graph 400, which includes two sub-graphs, a top graph 402 and a bottom graph 404. The X-axis of each graph represents a time period from 0 to 2/120ths of a second. The top graph 402 presents data corresponding to an image being loaded into and written from various components of the electronic device 100 (FIG. 1). The bottom graph 404 presents data associated with other aspects of presenting the image to the viewer. The data sets shown on the graph 400 represent one embodiment of the present invention. Those of ordinary skill in the art will appreciate that the rates at which data is loaded and written depend on the particular components which comprise the electronic device 100 (FIG. 1).

The Y-axis of the top graph 402 represents the fraction of an image being loaded into and written from various components of the electronic device 100 (FIG. 1). The scale ranges from 0 to the size of the image. The top graph 402 presents three data sets: a first data set 406 (shown as a solid line) including data being loaded into the frame buffer, a second data set 408 (shown as a dashed line) including data being written to the display 114 (FIG. 1) from the frame buffer, and a third data set 410 (shown as a dashed line having alternating long and short segments) relating to the pixels on the display 114 (FIG. 1) being updated to correspond to the image being written to the display 114 (FIG. 1) from the frame buffer. The Y-axis of the bottom graph 404 represents the states of the backlight 114 (FIG. 1) and a pair of LCD shutter goggles. The bottom graph 404 presents two data sets: a fourth data set 412 (shown as a solid line) representing the state of the backlight and a fifth data set 414 (shown as a dashed line) representing the state of a pair of LCD shutter goggles.

With regard to the backlight, the bottom of the graph represents a state where the display 114 (FIG. 1) is substantially dark and the top of the Y-axis represents a state where the display 114 (FIG. 1) is substantially illuminated. With regard to the pair of LCD shutter goggles, the bottom of the Y-axis represents a state in which the left lens is substantially clear and the right lens is substantially dark, while the top of the Y-axis represents a state in which the right lens is substantially clear and the left lens is substantially dark.

A series of events are presented along the X-axes of the graphs. The first event 416 corresponds to the start of the first data set 406, the start of the second data set 408, the start of the third data set 410 and the start of the fifth data set 414. In this exemplary embodiment, the steps which begin at the first event 416 occur at substantially the same time. In this context, substantially the same time means that each of the steps in the first event may begin as soon as practicable after the right image has been loaded into the frame buffer 202 (FIG. 2). The purpose of this requirement is to maximize the duration of a complete image on the display 114 (FIG. 1), while minimizing the transition time between images. For example, the sooner the frame buffer 202 (FIG. 2) begins writing the right image to the display 114 (FIG. 1), the longer the image will remain on the display 114 (FIG. 1) before the transition to the left image begins. However, the frame buffer 202 (FIG. 2) may not be able to begin writing the right image to the display 114 (FIG. 1) until the right image has been loaded into the frame buffer 202 (FIG. 2). Those of ordinary skill in the art will appreciate that slight variations in the commencement of these steps are tolerable in the present embodiment. However, the closer in time the steps of the first event begin, the better the 3D effect.

As previously explained, the amount of time required for an image to be loaded into the frame buffer 202 (FIG. 2) is equal to the video frame rate. Therefore, in the present embodiment, the left image requires 1/120th of a second to load into the frame buffer 406. Also, in the present embodiment, the frame buffer 202 (FIG. 2) is capable of writing data to the display 114 (FIG. 1) at a faster rate than data is loaded into the frame buffer 202 (FIG. 2). Hence, the slope of the frame buffer write curve (i.e., the curve of the second data set 408) is greater than the slope of the frame buffer load curve (i.e., the curve of the first data set 406). As soon as the frame buffer 202 (FIG. 2) begins to write data to the display 114 (FIG. 1), the pixels on the display 114 (FIG. 1) may begin to update to correspond to the new image. However, in the present embodiment, due to the response time inherent in LCD pixels, the amount of time required for all the pixels on the display 114 (FIG. 1) to be updated with a new image is greater than the time required to completely write the image to the display 114 (FIG. 1) from the frame buffer 202 (FIG. 2). Therefore, the slope of the display update curve (i.e., the curve of the third data set 410) is less than the frame buffer write curve. While transitioning the LCD shutter goggles from a state in which the left lens is substantially clear and the right lens is substantially dark to a state where the right lens is substantially clear and the left lens is substantially dark requires a finite amount of time, that time is relatively short compared to the other operations in the electronic device 100 (FIG. 1) in the present embodiment.

The second event 418 corresponds to the time when all the pixels on the display 114 (FIG. 1) have been updated. At that point, the backlight controller 204 (FIG. 2) may begin powering on the backlight, as illustrated by the fourth data set 412. The faster the backlight 116 (FIG. 1) is powered on, the longer the viewer will be able to see the image on the display 114 (FIG. 1). In the present embodiment, the backlight 116 (FIG. 1) causes the display 114 (FIG. 1) to transition from a state of being substantially dark to being fully illuminated in a period of time significantly less than the duration which the image is present on the display 114 (FIG. 1).

The third event 420 corresponds to the time when the backlight controller 204 (FIG. 2) powers off the backlight 116 (FIG. 1). The point when the backlight 116 (FIG. 1) is powered off depends on the backlight's response time. In the present embodiment, the backlight 116 (FIG. 1) is powered off such that the display 114 (FIG. 1) will be substantially dark before a subsequent image is written to the display 114 (FIG. 1). In this manner, the viewer may only see a complete eye-appropriate image during the period of time when the display 114 (FIG. 1) is illuminated.

The fourth event 422 corresponds to a time when the previously described events repeat for displaying the left image. At this point, a subsequent right image may be loaded into the frame buffer 202 (FIG. 2), the left image may be written from the frame buffer 202 (FIG. 2) to the display 114 (FIG. 1), the display 114 (FIG. 1) may begin to update the pixels with the left image and the LCD shutter goggles may begin to transition to displaying the left image to the viewer's left eye only. Similar to the first event 416, these steps may begin at substantially the same time.

The fifth event 424 corresponds to the backlight controller 204 (FIG. 2) powering on the backlight 116 (FIG. 1) such that the left image may be visible on the display 114 (FIG. 1). As with displaying the right image, this event commences when all the pixels on the display 114 (FIG. 1) have been updated to show the left image.

The sixth event 426 corresponds to the backlight controller 204 (FIG. 2) powering off the backlight 116 (FIG. 1) such that the left image may no longer be visible to the viewer. As with powering off the backlight 116 (FIG. 1) after displaying the right image, the backlight 116 (FIG. 1) must be powered off at a time that will facilitate the display 114 (FIG. 1) becoming substantially dark by the time the pixels begin to be updated with the right image. This cycle of loading the left image while displaying the right and loading the right image while displaying the left continues as long as the electronic device (100) is in operation.

While embodiments of the invention may be susceptible to various modifications and alternative forms, specific embodiments have been shown by way of example in the drawings and were described in detail herein. However, it should be understood that the embodiments of the invention are not intended to be limited to the particular forms disclosed. Rather, embodiments of the invention are to cover all modifications, equivalents and alternatives falling within the spirit and scope of the invention as defined by the following appended claims.

What is claimed is:

1. A method of operating a digital video device to create an effect of a three-dimensional image, the method comprising:
loading a left image into a frame buffer prior to displaying the left image on a display of the digital video device;
writing a right image to the display;
displaying the right image to a right eye of a viewer and substantially blocking the right image from display to a left eye of the viewer;
powering on a backlight of the display to allow the right eye of the viewer to view the right image;
powering off the backlight of the display;
loading a subsequent right image into the frame buffer prior to displaying the subsequent right image on the display;
writing the left image to the display;
displaying the left image to the left eye of the viewer and substantially blocking the left image from display to the right eye of the viewer; and
powering on the backlight of the display to allow the left eye of the viewer to view the left image.

2. The method recited in claim 1, wherein the steps of loading the left image into the frame buffer, writing the right image to the display, and displaying the right image to the right eye of the viewer begin at substantially the same time.

3. The method recited in claim 1, wherein the steps of loading the subsequent right image into the frame buffer, writing the left image to the display, and displaying the left image to the left eye of the viewer begin at substantially the same time.

4. The method recited in claim 1, wherein powering on the backlight of the display begins after each of a plurality of pixels on the display has been updated to correspond to the left or right image.

5. The method recited in claim 1, wherein powering off the backlight of the display begins at a time that will enable the display to be substantially dark before the step of writing the left or right image to the display begins.

6. The method recited in claim 1, wherein displaying the left image to the left eye of the viewer and substantially blocking the left image from display to the right eye of the viewer comprises turning on a left lens and turning off a right lens of a pair of LCD shutter goggles.

7. The method recited in claim 1, wherein displaying the right image to the right eye of the viewer and substantially blocking the right image from display to the left eye of the viewer comprises turning on a right lens and turning off a left lens of a pair of LCD shutter goggles.

8. The method recited in claim 1, wherein writing the left or right image to the display requires less time than loading the left or right image into the frame buffer.

9. The method recited in claim 8, wherein each of a plurality of pixels on the display is updated with the left or right image before the step of loading the left or right image into the frame buffer begins.

10. A digital video device that is adapted to create an effect of a three-dimensional image, the digital video device comprising:
a signal source input configured to receive a video signal;
a display configured to display images based on the video signal;
a processor configured to control the operation of the digital video device, the processor being configured to:
load a left image into a frame buffer prior to displaying the left image on the display;
write the left image to the display;
display the left image;
load a right image into the frame buffer prior to displaying the right image on the display;
write the right image to the display; and
display the right image; and
a backlight controller configured to power on a backlight of the display after the right image is displayed, to power off the backlight before the left image is written to the display, to power on the backlight after the left image is displayed, and to power off the backlight before the right image is written to the display.

11. The device recited in claim 10, further comprising a pair of LCD shutter goggles.

12. The device reciting in claim 11, wherein the state of a left lens and a right lens in the pair of LCD shutter goggles is controlled by the processor.

13. The device reciting in claim 12, wherein the processor is configured to turn the left lens substantially clear before the left image is displayed and turn the left lens substantially dark before the right image is displayed.

14. The device recited in claim 12, wherein the processor is configured to turn the right lens substantially clear before the right image is displayed and turn the right lens substantially dark before the left image is displayed.

15. The device recited in claim 10, wherein the frame buffer is configured to write the left or right image to the display faster than the left or right image is loaded into the frame buffer.

16. The device recited in claim 10, wherein the processor is configured to load the left image into the frame buffer and write the right image to the display at substantially the same time.

17. The device recited in claim 10, wherein the processor is configured to load the right image into the frame buffer and write the left image to the display at substantially the same time.

18. The device recited in claim 10, wherein the frame buffer is configured to load the left image and write the right image to the display at substantially the same time.

19. The device recited in claim 10, wherein the frame buffer is adapted to load the right image and write the left image to the display at substantially the same time.

20. A digital video device that is adapted to create an effect of a three-dimensional image, the digital video device comprising:
means for loading a left image into a frame buffer prior to displaying the left image on a display of the digital video device;
means for writing a right image to the display;
means for displaying the right image so that the right image is viewable only to a right eye of a viewer;
means for powering on a backlight of the display to allow the right eye of the viewer to view the right image;
means for powering off the backlight of the display;
means for loading a subsequent right image into the frame buffer prior to displaying the subsequent right image on the display;
means for writing the left image to the display;
means for displaying the left image so that the left image is viewable only to a left eye of the viewer; and
means for powering on the backlight of the display to allow the left eye of the viewer to view the left image.
